(19) United States
(12) Patent Application Publication
(10) Pub. No.: US 2002/0084981 A1
(43) Pub. Date: Jul. 4, 2002

(54) Cursor navigation system and method for a display

(76) Inventors: James F. Flack, Los Altos Hills, CA (US); Thierry Valet, Sunnyvale, CA (US)

Correspondence Address: OPPENHEIMER WOLFF & DONNELLY, P. O. BOX 10356, PALO ALTO, CA, 94303, US

(21) Appl. No.: 09/847,183

(22) Filed: May 2, 2001

Related U.S. Application Data
(60) Provisional application No. 60/248,935, filed on Nov. 14, 2000.

(51) Int. Cl. G09G 5/08

(52) U.S. Cl. 345/157

(57) ABSTRACT

The present invention is a cursor that reflects what portion of a virtual space a display is showing by the cursor being in a corresponding space on the display. Embodiments of this invention include the cursor being limited to movement within a cursor zone, and reflecting what portion of a virtual space is on display by having a corresponding position with the cursor zone. The cursor zone may have a variety of sizes, shapes and locations, and may also act as a scrolling barrier for contents of the virtual space.

This application claims priority, under 35 U.S.C. § 119(e), of U.S. provisional application 60/248,935, entitled “Fixed Cursor,” filed Nov. 14, 2000 which is incorporated herein by reference. This application is also filed contemporaneously with co-pending application, “Fixed Cursor,” which is incorporated herein by reference.

### BACKGROUND

As the use of computer devices becomes more ubiquitous, the amount of content being condensed into a display interface is drastically increasing. Text documents, flow chars, emails, pictures and much more are so large that they often can only have a portion of their contents displayed at an given time. The need for a user to be able to scroll in order to view different parts of the content becomes essential.

Advents such as the scroll bar have attempted to help interface a user with documents and images that are larger than the display space. One drawback, however, is that the scroll bars need to be broken down into two axes of movement, which is burdensome to use. Another drawback is that the scroll bars themselves take up a portion of the display screen, thereby reducing the viewing space. This can be seen in FIG. 1, where the scroll bars 16 move the contents 14 within a display 12. another cause of reduced viewing space is that multiple applications are often run at the same time, causing the need for a windows tool bar. Combine these windows toolbars with any given application toolbar(s) and scrolling bars, and the amount of viewing space on the display becomes even further limited.

To magnify this problem, while the percentage of viewing space on a display that is available for display is decreasing, so is the size of the display screen itself. Advents in the miniaturization of computer devices greatly decrease the amount of available viewing space. Lap-top computer, for example, obviously cannot have a display interface as large as desktop computers, and hand-held devices, which are growing the fastest in use, conversely have the smallest display interfaces.

Advances in toolbars, interfaces and scrolling systems have attempted to reduce the conflict between the need for greater amounts of displayed content and the need for smaller displaying devices. One advancement attempting to resolve this conflict can be found in U.S. patent application ser. No. 09/328,053 filed Jul. 8, 1999, which is incorporated herein by reference. In this application, a hand-held computer device scrolls its contents by moving the display device as if the display screen were a window looking through to a document in real space. In this manner the users have an intuitive sense of what section of the data they are looking at and how to easily navigate to other, off-display, parts.

Advances in these areas, however, have fallen short of being able to provide a user with a smooth interface, while at the same time, conserving on display space and complexity f controls.

What is needed is a better cursor interface for advanced scrolling systems while maintaining simple controls. Also what is needed is an interface that provides a user with an intuitive sense of what part of the document is being viewed without reducing display space.

### SUMMARY OF THE INVENTION

In one embodiment of the current invention, the contents on a display scroll while the cursor remains in a fixed location on the display.

In another embodiment of the current invention, control scroll the contents on a display, which causes the cursor to move to a location on the display screen that is in proportion to the section of the contents being displayed. For example, if the display is showing the upper left hand portion of a particular text, then the cursor is in the upper left hand portion of the display screen. when the center of the text is being displayed, then the cursor is in the center of the screen.

refinements of this embodiment include no-linear pacing of the cursor movement with the scrolling of the contents. For example, the cursor moves quickly across the display screen when the middle portions of the content are being displayed, but moves comparatively slower as the scrolling approaches the edges of the content.

further embodiments include a cursor zone, which is a region in which the cursor moves, and can corresponding represent the portion of the content on display by its position within the cursor zone. This cursor zone can be of any size, including larger than the display screen, but is preferably of a size that is slightly less than the perimeter of the image actually being displayed. most preferably, the cursor zone is a square with rounded corner, but can be of any shape.

Yet another embodiment limits the scrolling of the contents to the boundary of the cursor zone. In a refinement of this embodiment, a portion of the contents will always be visible within the cursor zone.

### BRIEF DESCRIPTION OF THE DRAWINGS

FIG. 1 depicts a display screen as per the prior art.

FIG. 2 shows a display screen with only a portion of the contents on display

FIGS. 3 to 5 shows how the cursor moves in accordance with the scrolling of the display screen.

FIGS. 6 and 7 shows a cursor zone to which the cursor's movement is limited.

FIG. 8 demonstrates an example of stopping the scrolling of contents by the boundary of the cursor zone.

FIG. 9 demonstrates another method of stopping the scrolling of the contents by the boundary of the cursor zone.

FIGS. 10 and 11 show the stopping of the scrolling as in FIG. 8 and 9 without the actual boundary depicted.

FIGS. 12 to 15 show various shapes and positions of the cursor zone.

FIGS. 16-18 show how a user may select a paragraph of text according to one aspect of the present invention.

FIG. 19 illustrates a display screen showing a portion of a virtual space, each having their axes labeled.

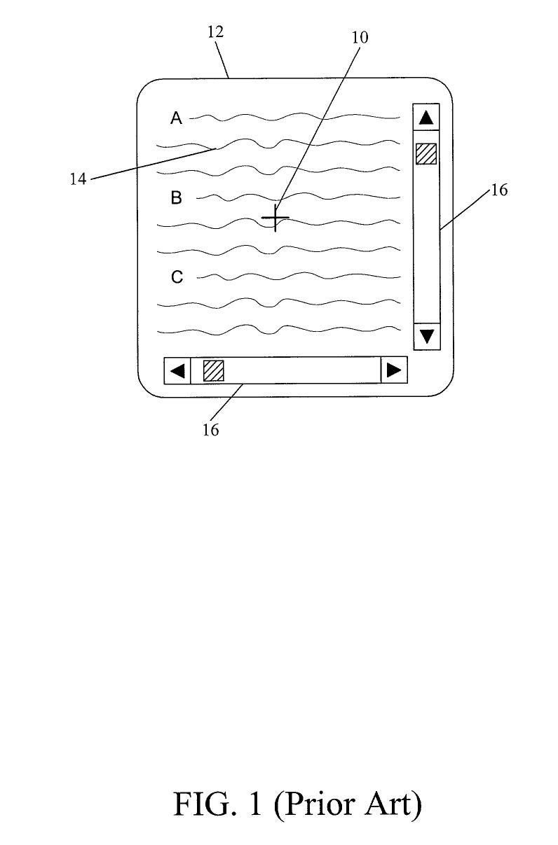

### DETAILED DESCRIPTION OF THE PREFERRED EMBODIMENTS

This invention seeks to improve user interfaces by improving how the cursor on a display device is used.

In one aspect, the invention seeks to solve the problem of when a display device can only show a portion of the contents being used. This occurs when a virtual space, which is defined as the total space a virtual image or document would take up if it really existed as seen, is larger than the amount of space allotted to it on a display. A user viewing only a portion of a virtual space, or contents, needs to know what portion of the contents, in regards to the whole, they are looking at. As mentioned above, scroll bars have attempted to solve this problem. However, scroll bars reduce the display field, and need to be split into axes. This aspect of the present invention solves the display field problem by moving the cursor on the display device in proportion to the part of the content that is being shown on the display.

For example, if the center of the contents is currently on display, then the cursor is located in the center of the display screen. If the top left-hand corner of the contents is on display, then the cursor would be located in the upper left hand corner of the display screen. The invention works best when there is freedom of scrolling motion in both the x and y axis, but there are still benefits to using the invention when there is only one axis of movement.

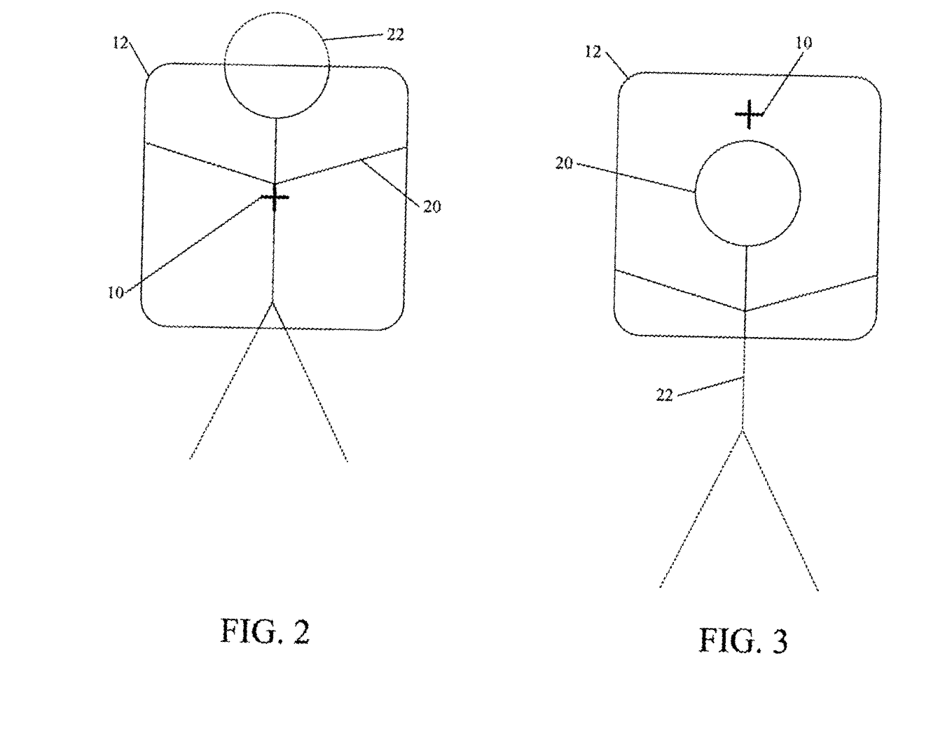

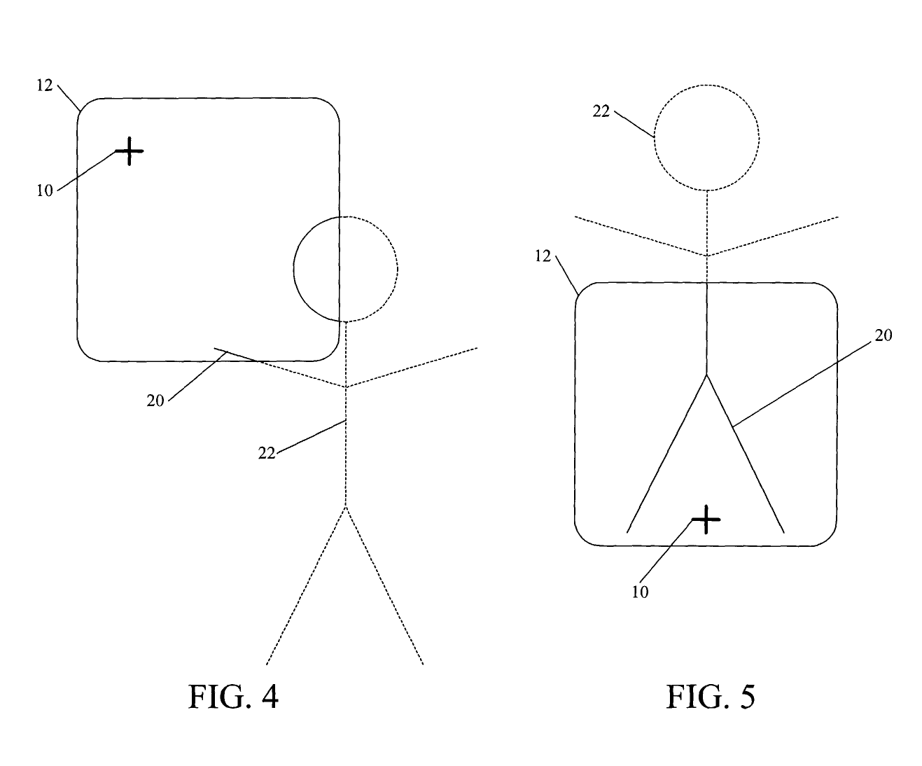

FIGS. 2 though 4 show examples of cursor movement where there are two degrees of freedom in the x and y axes. In FIG. 2 the display screen 12 in centered on a virtual image 22, of which only a portion is visible 29 on the display at a given time. Since, in this figure, the display 12 is focused at the center of the image 22, the cursor 10 is in the center of the display screen. As a user scrolls straight up, as in FIG. 3, the cursor 10 mover straight up the display screen 12. In FIG. 4 and 5, a user has scrolled to the upper left and the bottom center portion of the image 22 respectively, and the cursor 10 mimics which portion of the image 20 is being shown.

The speed of the cursor across the display can be linear, or almost any conceivable movement scale. Preferably, the cursor moves slower as it nears the perimeter of the display screen. Various features, well known in the prior art, can also be added to the cursor. For example, a pop up window that tells, in text, what part of the document or image the cursor is currently on top of.

In one embodiment, the cursor stops at the edge of a display screen, much a standard cursor. In another embodiment the cursor can stop at a location not on the display. however, in a preferred embodiment of this invention, the cursor has a limited field in which in can move, called a cursor zone, which is generally less than the perimeter of the display. In the example given above, when the top left-hand portion of the contents/virtual space is being displayed, the cursor is in the top left-hand portion of the cursor zone. this cursor zone can be of any size and shape, but practically speaking, would be less than the perimeter of the actual physical display. Optimally, the cursor zone has a perimeter the same as, or slightly less than, the perimeter of the part of the display that shows the virtual space.

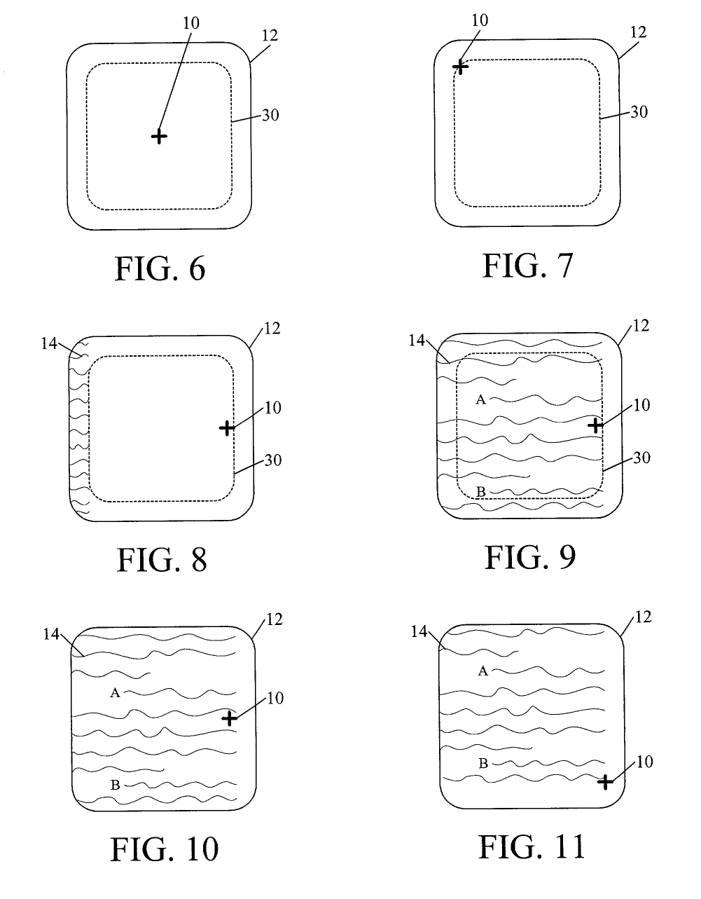

FIG. 6 shows a typical example of a cursor 10 within a cursor zone 30. While FIG. 7 shows actual restriction of the cursor's movements by the cursor zone 30. this embodiment can be combined with other embodiments, such as the speed of the cursor slowing as it nears the edge of the cursor zone. The cursor zone can be visible, or invisible, depending on user preference.

In yet another preferred embodiment, the cursor zone acts as a limit to the scrolling of the contents on the display screen. Contents, in this embodiment, refers to the contents of the virtual space that a user interprets to have some meaning. Often, the actual virtual space can be much larger than the content, in which case a user could be confronted with a completely blank display screen, having scrolled the contents off of the display. As shown in FIGS. 8 and 9, the scrolling of the contents 14 can be limited on either the near or far side of the cursor zone barrier 30. FIGS. 10 and 11 correspondingly show scrolling the contents of the display screen bound by the cursor zone without the cursor zone itself being displayed.

A model variety of a cursor zone would also be a typical word processing. the actual document on display in most word processing programs occupies about 70% of the actual screen, the remaining screen being occupied by various kinds of toolbars or documents formatting ingots. In the present invention the field in which the cursor moves would be confined to the portion of the screen dedicated to the text document.

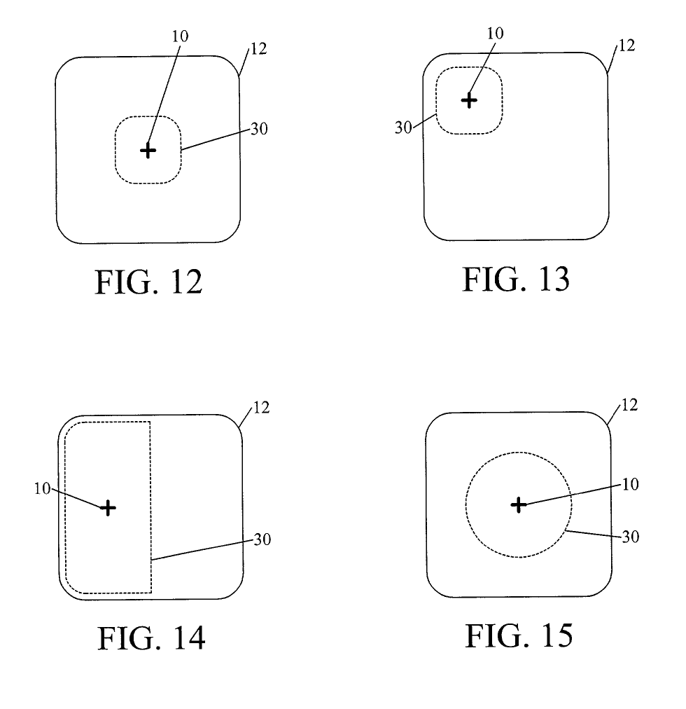

Variations on the cursor zone concept are virtually limitless. FIGS. 12 through 15 illustrate a few examples of this. the cursor zones 30 may be of any shape, in any position. The cursor zone can be a one-inch square in the center of the display screen, so that the cursor movement is mere token, or they can be ellipses whose edges disappear off the side of the display. The cursor zone itself is preferably invisible, but could be of some transparent color, or have just its perimeter showing. The perimeter and location of the cursor zone can also be adjustable.

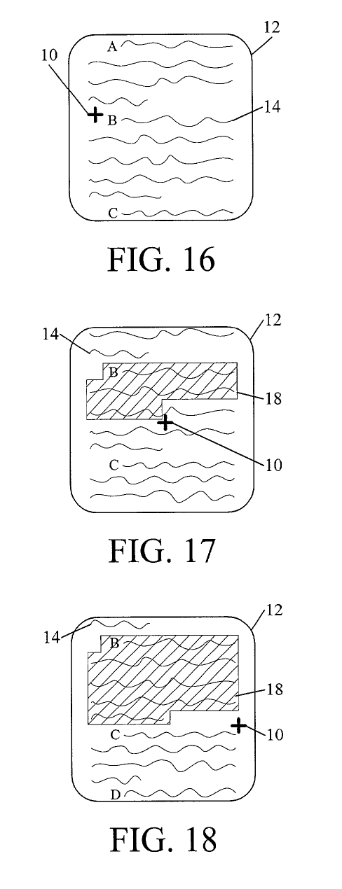

FIGS. 16 through 18 show one method of how the cursor according to one embodiment of the invention can be used to perform standard word processing functions such as selection of text. A portion of the text 14 is chosen by scrolling the text until the cursor 10 is over the place where selection is to begin. FIG. 17 shows the mid-way part of the selection, were the cursor 10 moves over the desired text 18 by scrolling the content upwards and to the left, until, as shown in FIG. 18, the entire desired text 18 is selected. It is worth noting that, in this example, the content is able to scroll up and down much more than it is able to scroll left and right. The scale of cursor movement, i.e. the ratio of movement of the cursor versus the span of the document scrolled, is much more dramatic from left to right as compared with the contents scrolling up and down.

It may also be the case where the document only scrolls in one direction, such as up and down. In this case, the user may opt to have the horizontal scroll commands move the cursor. This would create a hybrid between a regular cursor movement and the scroll based movement cursor. Also, if the user is confronted with the document that does not scroll at all, the scroll commands can be toggled to function as regular cursor movement commands.

In these figures, the movement of the cursor is quite dramatic for illustrative purposes. As mentioned later, it is possible to set the pacing of the cursor so that the movement is slight. It is even possible to reduce the tracking to zero, so that the cursor remains in a fixed location while all the above mentioned applications are preformed. The cursor may be fixed in any portion of the display screen or cursor zone, but preferably towards the center.

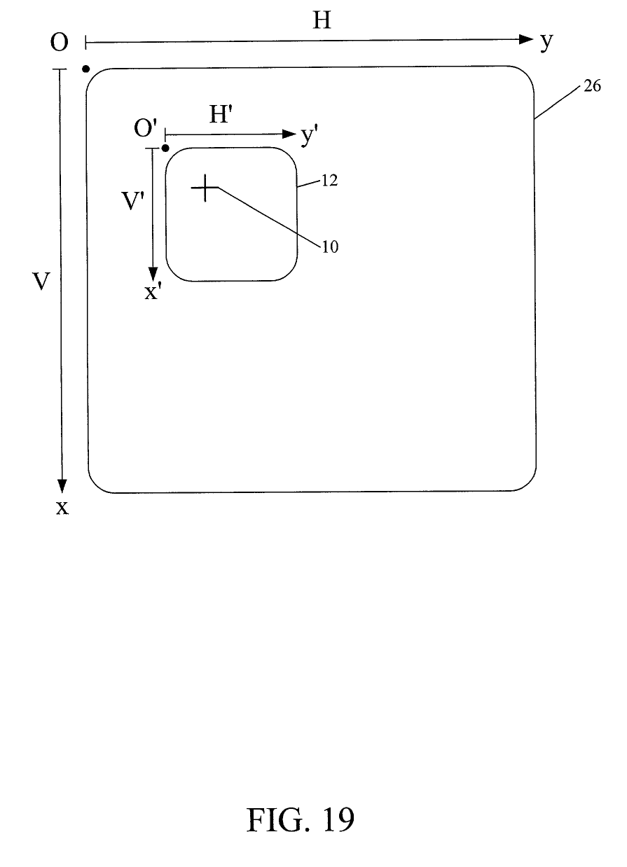

FIG. 19 illustrates a display screen 12 showing a portion of a virtual space 26. For clarity, the axes and origins are labeled. the origin of the virtual space is marked by an O, the horizontal axis by a Y, the vertical by an X, with the actual virtual space occupied by the horizontal and vertical axis being labeled H and V respectively. the display space has corresponding symmetry, labeled O′, Y′, X′, H′ and V′. The cursor 10 may be referred to as C (not shown).

A variety of formulas to calculate the position of the cursor within the display space would be apparent to one of ordinary skill in the art. A preferred formula is:

$${X}^{′} c = f ( \frac{{H}^{′}}{H} ( {Xo}^{′} ) , \frac{{H}^{′}}{H} ( {Yo}^{′} ) )$$

$${Y}^{′} c = g ( \frac{{H}^{′}}{H} ( {Xo}^{′} ) , \frac{{H}^{′}}{H} ( {Yo}^{′} ) )$$

$$where$$

$$\frac{{X}^{′} c}{V} = \frac{{Xo}^{′}}{{V}^{′}} and \frac{{Y}^{′} c}{H} = \frac{{Yo}^{′}}{{H}^{′}}$$

Setting the function f and g to desired parameters would produce the myriad of effects discussed above. Some of the more preferred effects that can be influenced by a change to for g including a slower movement of the cursor as the display screen 12 approaches the edges of the virtual space 26, a non-equal pacing between the two movement axis of the cursor, as well as a complete halting of all cursor movement.

At times, there will still be an anticipated need to move the cursor independently of the document or image on display. This could be when a user whishes to access a toolbar without scrolling the contents to get the cursor in range of the toolbar, or when the field of the cursor does not even extend to the toolbar. There could also be multiple documents on display and the user wishes to move the cursor from one to the other without scrolling the first document. Also, there could be multiple documents on the display, each with its own cursor zone. These are just a few examples of the vast number of instances when a user might not wish the cursor to necessarily reflect the position of the contents being displayed. There are, of course, ways to adjust the user of the present invention to handle these needs. One solution is to simply toggle the display tracking feature. Another solution is to have a supra mode, where the cursor jumps to the toolbar or another document and can be navigated from there. Multiple supra modes can be used for multiple toolbars. This feature might also include multiple cursors, one for the contents, and another for the program features, or a cursor for each document on display. The two cursors could be shown simultaneously, or one could be hidden or changed in appearance when not in use.

An alternate way of looking at the invention is a cursor that is positioned at a location on a display, and based on the position of the cursor, a data file is scrolled to the appropriate location. This is just another way of looking at the same invention, and all of the embodiments and explanations discussed above apply here equally.

What is claimed is:

1. A cursor for a display comprising:
a computer system with screen for showing the display and a set of user interface controls;
data shown on the display, the data having a virtual space equal to or greater than a portion of the display allotted to displaying the virtual space; and
movement controls that move the data in relation to the display;
wherein the cursor is at a position on the display that correlates to the portion of the data the data being shown on the display.

2. A cursor for a display as in claim 1, wherein the cursor is limited to movement within a cursor zone, whereby the cursor is at a position in the cursor zone that correlates to the portion of the data being shown on the display.

3. A cursor for a display as in claim 2, wherein at least a portion of the cursor zone is within the perimeter of the display.

4. A cursor for a display as in claim 2, wherein moving of the data shown on the display is stopped by the edges of the cursor zone.

5. A cursor for a display as in claim 2 wherein the cursor zone is entirely within the perimeter of the display.

6. A cursor for a display as in claim 1, wherein the cursor moves at a greater rate when the display is displaying a center portion of the data versus an edge portion of the data.

7. A cursor for a display as in claim 1, wherein the speed of movement of the y axis of the cursor is at a different rate than the speed of movement of the x axis of the cursor.

8. A cursor movement system comprising:
a computer system;
a cursor;
a display capable of showing the cursor; and
a virtual image, wherein the display is able to show only a portion of the virtual image at a time;
wherein the cursor moves on the display relative to the portion of the virtual image on the display, whereby a user can ascertain which portion of the virtual image is being shown by the position of the cursor on the display.

9. A cursor for a display as in claim 8, wherein the cursor is bound by the perimeter of the display.

10. A cursor for a display as in claim 8, wherein the cursor is bound by the perimeter of the virtual image on display on the display.

11. A cursor for a display as in claim 8, wherein the cursor is bound by a cursor zone within the perimeter of the display.

12. A cursor movement system as in claim 11, wherein the cursor zone is centered on the virtual image shown on the display.

13. A cursor for a display as in claim 8, wherein a content in the virtual image will not scroll past the cursor zone.

14. A cursor for a display as in claim 8, wherein the position of the cursor on the display is opposite the position of the portion of the virtual image shown on the display.

15. A method for scrolling contents on a display, comprising:
having a virtual content;
having a portion of the display show the virtual content;
having a cursor;
wherein movement of the cursor over the portion of the display for showing the virtual content scrolls the virtual content; and
wherein the display shows a portion of the virtual content that correlates to the position of the cursor.

16. A method for scrolling content on a display as in claim 15, wherein the movement of the cursor is limited to a cursor zone.

17. A method for scrolling content on a display as in claim 16, wherein the portion of the virtual content that correlates to the position of the cursor is based on the position of the cursor in the cursor zone.

18. A method for scrolling content on a display as in claim 16, wherein the virtual content will not scroll past a predetermined edge of the cursor zone.

19. A method for scrolling contents on a display as in claim 15, wherein movement of the cursor over a center of the portion of the display for showing the virtual content produces a different scrolling speed than movement of the cursor over an edge of the portion of the display for showing the virtual content.

20. A method for scrolling content on a display as in claim 15, wherein the scrolling of the virtual content is discontinuous, such that scrolling is only performed when a user activated that function.

21. A cursor movement system for a display wherein the display shows only a portion of a virtual document, wherein a cursor used for carrying out functions on the virtual document remains in a fixed position relative to the perimeter of the display when the display is scrolling the virtual document.

22. A cursor for a display comprising:
data shown on the display the data having a virtual space equal to or greater than the display; and
movement controls that move the data in relation to the display;
wherein the cursor is at a position in the display that correlates to the portion of the data being shown on the display.
